(19) United States
(12) Patent Application Publication
(10) Pub. No.: US 2007/0076743 A1
(43) Pub. Date: Apr. 5, 2007

(54) Method and Related Apparatus for Realizing Network Medium Access Control

(76) Inventors: Sheng-Chung Chen, Taipei Hsien (TW); Jung-Tsan Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/531,701

(22) Filed: Sep. 14, 2006

(30) Foreign Application Priority Data
Sep. 15, 2005 (TW) 094131910

(51) Int. Cl. H04L 12/413

(52) U.S. Cl. 370/445

(57) ABSTRACT

In network systems having a wireless medium, such as IEEE802.11e based networks, each frame of a station is classified as one of a plurality of traffic categories, and frames of some traffic categories have a higher transmission opportunity than frames of other traffic categories. Before a station transmits frames to the network media, a media access control circuit in the station performs an internal access to read the frames from a system memory of the station. While performing the internal access, the presented invention reads frames in an order corresponding to media accessing priorities assigned in traffic categories of those frames, such that hardware cost, complexity and layout area of the medium access control circuit are all reduced.

### BACKGROUND OF THE INVENTION

1. Field of the Invention

The present invention relates to a method and related apparatus for realizing network medium access control, and more particularly, to a method and related apparatus for realizing network media access with simplified circuits.

2. Description of the Prior Art

Various network appliances such as terminals can be connected to a network system with a network media. In this way, the network appliances can connect to each other for rapidly transferring data, files, and video messages. The network system thus becomes critical to modern society. Recently, wireless network usage continues to expand, wireless networks have developed significantly. It is especially easy for the wireless networks to expand rapidly because they are not limited to physical network wires. For example, the wireless networks based on the IEEE 802.11 protocol are getting increasingly popular. Therefore, it is important that how to set up wireless network systems at a lower cost.

In a network system, since the network appliances are connected by a shared medium, the network appliances of the network system must follow specific rules and protocols to coordinate the accesses of the network appliances to the shared medium. For example, in the wireless network, accesses of the stations to the wireless medium are coordinated according to CSMA (Carrier Sensing Multiple Access) and CA (Collision Avoidance), wherein the wireless network is defined by the IEEE 802.11 protocol. According to the essential coordinate functions of CSMA and CA, it is to be detected that whether the wireless medium is idle or whether some other stations send frames before the station A transmits messages in the form of frames to the wireless medium. When the wireless medium is idle, the station A starts a countdown according to a back-off time interval that is randomly selected by the station A. When the countdown of the back-off time interval expires and the wireless medium remains idle, the idle time of the wireless medium exceeds the back-off time interval of the station and the station A is authorized to have access to the wireless medium for transmitting frames. Otherwise, if the wireless medium is occupied by another station before the countdown expires (e.g., another station has begun transmitting frames), the station A breaks the countdown. After a period of time, the station A continues the countdown of the back-off time interval in order to have access to the wireless medium when the station A detects that the wireless medium is idle again. The operations of CSMA and CA as briefly summarized above are well known to those of average skill in the related art and therefore additional details are omitted herein for the sake of brevity.

The aforementioned illustration shows that accesses of the stations to the wireless medium are coordinated according to the back-off time intervals of the stations. When the station A and a station B contend for the access to the wireless medium to connect to the network, both the station A and the station B start countdowns respectively and simultaneously after the station A and the station B detect that the wireless medium is idle. However, the station A and the station B set their own back-off time respectively and independently, the lengths of the back-off time intervals of the station A and the station B are the most likely different. Therefore, the station having a shorter back-off time interval finishes the countdown early and has the access to the wireless medium to begin a frame transmission. At the same time, the station having a longer back-off time interval detects that the other station is sending a frame. Furthermore, the station having a longer back-off time interval temporarily halts the access to the wireless medium until the wireless medium is idle again. In fact, the back-off time interval of each station is denoted as DIFS+CW according to the essential coordinate functions. DIFS is distributed inter-frame space and is a constant, and CW is contention window and is further denoted as (Rn*T_slot), wherein Rn is an integer among some specific parameters, and T-slot is a time slot constant. Since the length of CW is random, the length of the back-off time interval is also random.

Although most network systems, such as wireless networks under the IEEE 802.11 protocol, already have the essential coordinate functions, specific demands are still required for coordination of accesses to a wireless medium due to various applications of the network. For example, some network appliances must access the medium more frequently in order to perform the real-time video transmission through a network. On the contrary, some other network appliances merely access simplified data or text, and have significantly less requirements for accessing the medium. For satisfying the various requirements and the quality of service (QoS), the essential coordinate functions between the network appliances are enhanced in some network systems. For example, an additional protocol ‘IEEE 802.11e’ for wireless networks under the IEEE 802.11 protocol is added in order to support QoS.

According to the IEEE 802.11e protocol, additional enhanced coordinate functions are applied. A station based on the enhanced coordinate functions could categorize frames into various traffic categories according to various access requirements. Various random back-off time intervals of statistical properties are set on the basis of frames of various traffic categories. For example, when a first frame of a traffic category TC1, and a second frame of a traffic category TC2, of a station will be transmitted to the medium, the station randomly sets back-off time intervals for each frame after the medium is idle. The station also starts countdowns when the medium is idle. If the medium remains idle and the countdown of the frame of the traffic category TC1 expires, the station transmits the frame of the traffic category TC1 to the medium before all the other frames. The frame of the traffic category TC2 cannot contend for the access to the medium until the medium is idle again.

Furthermore, in the same station, frames of different traffic categories are regarded as frames of different virtual stations so that different virtual stations must contend for the access to the medium according to their own back-off time intervals. Undoubtedly, different physical stations always contend for the access to the medium. QoS is thereby achieved by setting various random back-off time intervals of statistical properties for various traffic categories. For example, because of the shorter back-off time intervals that are set for frames of the traffic category TC1, the frames of the traffic category TC1 may access the medium more frequently. On the contrary, because of the longer back-off time intervals that are set for frames of the traffic category TC2, the frames of the traffic category TC2 access the medium less frequently than the frames of the traffic category TC1. Therefore, in a wireless network, when some stations (i.e., network appliances) of the wireless network require real-time network services, those stations requiring real-time network services transmit information with frames of the traffic category TC1. Alternately, when other stations require network services with less real-time properties, those stations may access the medium by utilizing frames of the traffic category TC2. In fact, according to the IEEE 802.11e protocol, four specific traffic categories are supported within a single station. The operations of IEEE 802.11e such as the mentioned above are well known to those of average skill in the pertinent art and therefore additional details are omitted herein for the sake of brevity.

Physical circuits are implemented for carrying out the essential coordinate functions and the enhanced coordinate functions. Generally speaking, the network appliances, such as the terminals or the stations, in a network system are implemented with a computer system. As is well known by those of average skill in the related art, such computer systems include a central processing unit, a system memory, a bridge (for example, the north bridge chip sets and the south bridge chip sets), and network interface circuits utilized for achieving a physical access to a medium. Thereby, the user may access network resources by using the computer system. When a computer system is utilized to implement the essential coordinate functions and the computer system transmits a frame to the medium, a central processing unit (CPU) of the computer system first places said frame into the system memory. Next, the internal access module of the network interface circuit performs an internal access through the bridge for loading the frame into the system memory and storing the frame into a register module of the network interface circuit. For example, the network interface circuit may perform the internal access by utilizing a direct memory access (DMA) mechanism. Next, the network interface utilizes a media access mechanism for the frame transmission according to the essential coordinate functions. The frame transmission includes the following steps. Under the media access mechanism, a master module detects whether the medium is idle. When the medium is idle, the master module sets a back-off time interval for the frame under the media access mechanism so that the frame contends for the access to the medium. Finally, when the frame is authorized to access the medium, a register control module of the network interface circuit transmits the frame from the register module to the medium. The operations of frame transmission as briefly summarized above are well known to those of average skill in the pertinent art and therefore additional details are omitted herein for the sake of brevity.

The above-mentioned description relates to network circuits in a computer system with the essential coordinate functions, and in particular to the network interface circuit. When it is necessary for implementing the enhanced coordinate functions, the corresponding hardware of the computer system, such as the network interface circuit, must be provided. According to the IEEE 802.11e protocol, each station must support four different traffic categories. The 802.11e protocol also specifies that the frames of different traffic categories must contend for access to the medium, wherein the four traffic categories are regarded as four virtual stations in a physical station. Thereafter, an internal access module, a register module, and a register control module are typically used to deal with each frame of every traffic category in a network interface circuit of a computer system so as to implement the enhanced coordinate functions. For an instance, there exists the internal access module, the register module, and the register control module corresponding to the traffic category TC1 for retrieving the frames of the traffic category TC1 from the system memory, intermediately buffering the frames, and then transmitting the frames to the medium while the frames are authorized to access to the medium. Similarly, frames of the traffic category TC2 are transmitted in the same way.

However, the structure of the network interface circuit can be more complicate, and the cost and power consumption of the circuit design will be greater if an independent set of the internal access module, the register module, and the register control module are set up in accordance with each of the four traffic categories. Besides, an encrypted protocol is constructed in a network system for maintaining privacies of the network appliances in the network system. Generally speaking, a pre-processing module is utilized for encryption and is disposed in the register module that buffers the frames in a network interface circuit. Therefore, the frames in the register module are transmitted to the medium after they are encrypted. As a result, four additional independent pre-processing circuits are constructed in accordance with each of the traffic categories, and a bigger cost, increasing power consumption and a blockage of the network construction occurs.

### SUMMARY OF THE INVENTION

The invention relates to a method of media access control (MAC) implementation for enabling a station, which comprises a register module, to access a network through a medium. The method includes the following steps. First, a plurality of traffic categories is set. Each of a plurality of frames is conformed to one of the traffic categories before the station transmits information in the form of the frames to the medium. Sequentially, it is to be identified that whether the medium is idle before the frames are ready to be transmitted. Then a specific one of a plurality of back-off time intervals is assigned to the frames respectively while the medium is idle. If the group of frames is transmitted to the medium, a group of frames, which belong to a high priority group of the traffic categories, are buffered into the register module according to a priority prediction. Finally, a countdown is started according to the specific one of the back-off time intervals while the priority prediction is performed, wherein the back-off time intervals, which determines a priority of each of the traffic categories, are compared by the priority prediction, and a specific frame is transmitted from the register module to the medium if the idle time of the medium reaches a specific back-off time interval assigned to the specific frame that is buffered in the register module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating how different traffic categories of the same station contend for access to the medium according to the IEEE 802.11e protocol.

FIG. 2 is a block diagram of a first embodiment of a station of the present invention.

FIG. 3 is a diagram of the media access control circuit performing the enhanced coordinate functions in the present invention.

FIG. 4 is a diagram of the operations of the media access circuit while the priorities of the traffic categories are updated.

FIG. 5 is a block diagram of a second embodiment of the station in the present invention.

FIG. 6 is a diagram of the media access control circuit performing the enhanced functions.

FIG. 7 is a block diagram of a third embodiment of the station in the present invention.

FIG. 8 is a diagram of another embodiment of the network interface circuit and the media access control circuit in the station of the present invention.

FIG. 9 is a diagram of the procedure of the present invention.

### DETAILED DESCRIPTION

Certain terms used in the following description are claimed to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

In fact, at most one frame of one traffic category is transmitted to the medium in the network at the same time, although a plurality of traffic categories should be provided in a single station according to the operation of the enhanced coordinate functions. In the present invention, the distinguishing feature is utilized to simplify the complexity of a network interface circuit having the enhanced coordinate functions. Therefore, in an embodiment of the present invention, there are a single pre-processing circuit and only one set of an internal access module, a register module, a register control module, and a predicting module coordinating the operation of the internal access module in the network interface circuit. When a plurality of frames of various traffic categories in the system memory contend for access to the medium, the predicting module determines which is the frame of the specific traffic category that will have the right to gain the access to the medium before the medium begins to idle. The predicting module also controls the internal access module to load the frame of the specific traffic category, and to store the frame in the register module. The frame is encrypted before it is to be stored into the register module if it is necessary to perform a pre-processing procedure. After gaining the access to the medium, the frame is transmitted to the medium by the register control module. Meanwhile, the other frames of the traffic categories remain to be stored in the system memory without loading them into the register module. In other words, by coordination of the predicting module, the internal access module loads the frames into the system memory according to the priority of the frames. It is also unnecessary to dispose an independent set of the internal access module, the register module, and the register control module for each of the traffic categories.

In another embodiment of the present invention, the network interface circuit comprises a pre-processing circuit, an internal access module, a register control module, and a register module having a plurality of registers, wherein a specific traffic category is conformed to each of the registers. A predicting module is also utilized to coordinate the internal access module for ordering the internal accesses in the network interface circuit. When a plurality of frames of various traffic categories in the system memory contend for access to the medium, the predicting module determines which is the frame of the specific traffic category will have the right to gain the access to the medium before the medium begins to idle. The predicting module also controls the internal access module to load the frame of the specific traffic category, and to store the frame in the register module. The frame is encrypted before it is to be stored into the register module if it is necessary to perform a pre-processing procedure. After gaining the access to the medium, the frame is transmitted to the medium by the register control module. This embodiment of the present invention may also reduce the manufacturing cost, the required physical area, and the power consumption, of the internal access module, the register control module, and the pre-processing circuit.

In other words, the internal access module of the present invention loads frames of various traffic categories from the system memory to the network interface circuit according to the priorities of the frames of the traffic categories for accessing the medium. Therefore, the timing controls under the internal access mechanism and of the frame transmission and medium access in the network circuit are coordinated. Moreover, it is also unnecessary to dispose an independent set of the internal access module, the register module, and the register control module for each of the traffic categories. Therefore, the manufacturing cost, the required space, and the power consumption of the network interface circuit are reduced in the present invention, and the network is more popular among the public for sharing.

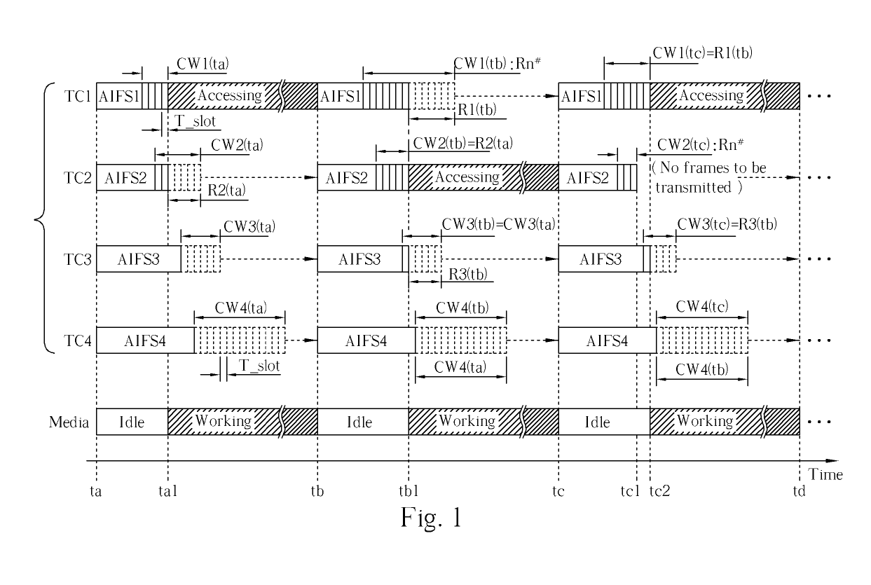

Before describing the details of the present invention, it is advantageous to provide an introduction by briefly discussing the operations of the enhanced coordinate functions. Turning first to FIG. 1 and taking a wireless network with the enhanced coordinate functions under the IEEE 802.11e protocol for example. FIG. 1 is a diagram illustrating how different traffic categories of the same station contend for access to the medium under the IEEE 802.11e protocol, and the horizontal axis of FIG. 1 represents the time. As shown in FIG. 1, frames are classified into four traffic categories TC1, TC2, TC3, and TC4 due to the application requirement before the station A transmits information in the form of frames to the medium. Please note that the four traffic categories are also officially denoted as: V0, V1, BE, and BK under the IEEE 802.11e protocol. As the mentioned before, the traffic categories contend for the access to the medium according to the corresponding countdowns of the back-off time intervals for coordinating the right with the access to the medium of the traffic categories. For an i^{th} traffic category TCi (i=1˜4), the length of the corresponding back-off time interval is equal to the sum of an arbitration inter-frame space AIFSi and a contention window CWi. Please note that the arbitration inter-frame space AIFSi is a specific constant and lengths of arbitration inter-frame spaces of different traffic categories are not the same. In FIG. 1, the arbitration inter-frame space AIFS1 of the traffic category TC1 has the narrowest length. In the next places, the arbitration inter-frame space AIFS2 and AIFS3 of the traffic category TC2 and TC3 have larger lengths than the traffic category TC1 has. Moreover, the arbitration inter-frame space AIFS4 of the traffic category TC4 is the longest. Besides, the contention window CWi in accordance with the traffic category TCi is a random number, and is randomly generated from a specific range with uniform distribution of the contention window. The ranges of the different contention windows in accordance with different traffic categories are also different and a specific arbitration inter-frame space of a specific traffic category is conformed to a specific contention window with a narrower range. Therefore, in accordance with the traffic category TC1, the arbitration inter-frame space AIFS1 has the narrowest length and the contention window CW1 has the narrowest range. Furthermore, the expected values of the contention window CW1 and the back-off time interval are also the smallest according to the traffic category TC1. In fact, each contention window of each traffic category has a length equals to the product of a random integer and a time slot T_slot. The random integer is selected from the range of the contention window in accord with the traffic category and the parameter of the contention window CW1 of the traffic category TC1 is the smallest.

As shown in FIG. 1, the medium has been utilized to transmit frames by a station before a time ta. Then, at the time ta, the medium begins to idle and when frames of the four traffic categories are supposed to contend for access to the medium in the station A, random back-off time intervals of the four traffic categories are set respectively. Each of the random back-off time intervals is constructed from the sum of a contention window and an arbitration inter-frame space such as AIFSi+Cwi (ta). Please note that the value of index i ranges from 1 to 4, and the contention window Cwi (ta) is determined at the time ta. Therefore, the countdown of each back-off time interval of the traffic categories is started at the time ta. The back-off time interval of the traffic category TC1 at the time ta is the shortest so that the countdown of the back-off time interval of the traffic category TC1 is finished first at the time ta1 and the medium remains idle. Meanwhile, at the time ta1, the traffic category TC1 gains access to the medium, and the station A subsequently transmits a frame of the traffic category TC1 to the medium. From another point of view, the frame is utilized to connect with the network and access the network resources. For example, the frame is transmitted to another station through the medium, and the original station waits for a positive acknowledge that is issued from the receiving station. Since the traffic category TC1 gains access to the medium at time ta1, the countdowns of the corresponding traffic categories TC2, TC3, and TC4 are stopped respectively at the time ta1 to forfeit their access to the medium temporarily and do not contend for access to the medium again until the medium is once again idle.

At the time tb, the frame of the traffic category TC1 has been transmitted, and the station A is aware that the medium is once again idle. At the time tb, the back-off time intervals of the traffic categories are reset respectively and once again the traffic categories contend for access to the medium. While each of the back-off time intervals is reset, a new contention window, which belongs to the traffic category with a frame being just transmitted, is also randomly generated. For example, a new contention window CW1 (tb), which belongs to the traffic category TC1, is generated while the frame of the traffic category TC1 has been transmitted, and the new contention window CW1 (tb) and arbitration inter-frame AIFS1 are summed to generate a new back-off time interval at time tb. In fact, the range of the contention window is adjusted according to the conditions that the frames will be transmitted or received while the contention window is randomly generated. For example, the frame of the traffic category TC1 is transmitted between the time ta and the time tb, and it indicates that the transmission in the medium is unstable if a positive acknowledge from another station is not received. When a new contention window is randomly generated at the time tb, the new contention window will be generated from the increased range of the original contention window of the traffic category TC1. Otherwise, if a positive acknowledge from another station is received between the times ta1 and tb, it is unnecessary for the traffic category TC1 to increase the range of the contention window.

Besides, for a frame that belongs to another traffic category and can't be transmitted, a new contention window is constructed from the uncounted part of the original contention window if a previous back-off time interval has been counted down in the phase of the contention window. In FIG. 1, when a back-off time interval, which belongs to the traffic category TC2, is counted down from the time ta to the time ta1, a part of the contention window CW2 (ta) has been counted and the uncounted part of the contention window CW2 (ta) becomes the time interval R2 (ta). Therefore, at time tb, a new contention window CW2 (tb), which belongs to the traffic category TC2, is constructed from the time interval R2 (ta), and the new back-off time interval set at time tb is equal to the sum of the arbitration inter-frame space AIFS2 and the contention window CW (tb). Furthermore, for a frame that belongs to another traffic category and can't be transmitted, a new contention window is the same as the original contention window when a previous back-off time interval has been counted down in the phase of the arbitration inter-frame space. In FIG. 1, new contention windows CW3 (tb) and CW4 (tb) are the same as the original contention windows CW3 (ta) and CW4 (ta) respectively when previous back-off time intervals of the traffic categories TC3 and TC4 have been counted down respectively in the phase of the corresponding arbitration inter-frame space at time ta1.

After resetting the corresponding back-off time intervals respectively, the countdowns of the corresponding back-off time intervals of different traffic categories are started for contending for access to the medium once again. In FIG. 1, the back-off time interval of the traffic category TC2 at the time tb is the shortest so that the countdown of the back-off time interval is the first to be finished and the medium remains idle. Meanwhile, the traffic category TC2 gains access the medium, and the station A transmits a frame of the traffic category TC2 to the medium and accesses the network through the frame. At the time tb, the countdowns, which belong to the traffic categories TC1, TC3, and TC4 respectively, are stopped and the traffic categories TC1, TC3, and TC4 wait for the medium to be idle again.

At the time tc, the back-off time intervals of the traffic categories are reset respectively. For example, the contention window CW2 (tc), which belongs to the traffic category TC2, is randomly reset. The uncounted parts R1 (tb) and R3 (tb), which belongs to the traffic categories TC1 and TC3, are regarded as the contention windows CW1 (tc) and CW3 (tc) respectively. The back-off time interval, which belongs to the traffic category, is counted down to contend for access to the medium at the time tc. In FIG. 1, the back-off time interval of the traffic category TC2 is the shortest at the time tc so that the countdown of the back-off time interval of the traffic category TC2 is first finished at the time tc1. However, no frames of the traffic category TC2 is to be transmitted at the time tc1 so the other back-off time intervals, which belongs to the other traffic categories, are kept on counting down to contend for access to the medium. At the time tc2, the countdown of the back-off time interval of the traffic category TC1 with a frame to be transmitted is finished, and the medium remains idle. A frame of the traffic category TC1 therefore gains access to the medium, and the station A transmits the frame to the network through the medium at the time tc2.

As the mentioned above, the detail of the enhanced coordinate functions is disclosed, and the traffic category with the smaller back-off time interval gains access to the medium more easily and accesses the medium more frequently. So, urgent network messages such as real-time audio and video signals are easily carried via the traffic category with a smaller arbitration inter-frame space and a smaller expected contention window. On the contrary, network messages without timeliness are usually carried via the other categories that hardly gain the access to the medium. Besides, as the mentioned before, in a network, the traffic categories of the same station compete with not only each other, but also other traffic categories in different stations. Each traffic category of stations shares the same medium in the network after all. For example, in FIG. 1, another station is supposed to transmit frames and occupy the medium so that the back-off time intervals of the traffic categories TC1, TC2, TC3, and TC4 of the station A are stopped counting down. Therefore, each back-off time interval will not be reset until the medium is idle to be accessed.

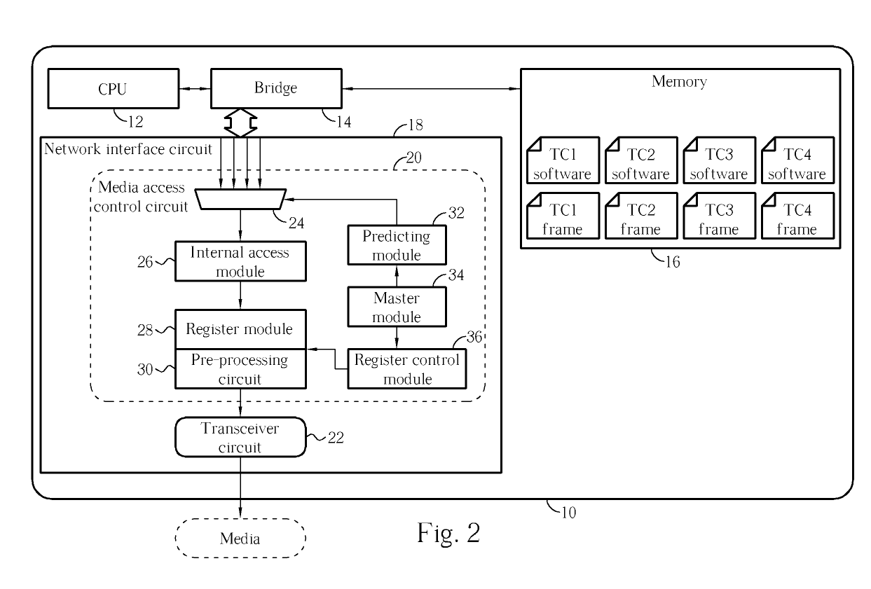

FIG. 1 illustrates a situation where the traffic categories in a station having the enhanced coordinate functions contend for access to the medium. As the mentioned before, a plurality of traffic categories in a station having the enhanced coordinate functions contend for access to the medium as if a plurality of virtual stations with the essential coordinate functions just contend for the access to the medium in the station. An embodiment of the present invention is disclosed as the followed description, and in FIG. 2, simplified circuits are utilized to implement the enhanced coordinate functions in the embodiment.

Please refer to FIG. 2 and FIG. 2 is a block diagram for carrying out the present invention in a station 10 according to an embodiment. The station 10 is a network appliance of a network system, and can be regarded as a computer system that includes a central processing unit 12, a bridge 14, a memory 16 acting as a system memory (e.g., a dynamic random access (DMA) memory), and a network interface circuit 18. The central processing unit 12 is utilized for controlling the station 10, executing programs, and calculating data. The memory 16 is utilized for providing system memory space and storing related programs and data while the central processing unit 12 is working. The network interface circuit 18 connects to the medium of the network and physically transmits frames to the medium so that the station 10 connects to the network and accesses resources of the network. The bridge 14 may be a north bridge/south bridge or a chip set. The bridge 14 is utilized to coordinate the communications between the central processing unit 12, the network interface circuit 18, and the memory 16.

A media access control (MAC) circuit 20 and a transceiver circuit 22 are further disposed in the network interface circuit 18. The media access control circuit 20 is utilized to manage the access to the medium in the station 10. The transceiver circuit 22 comprises hardware utilized for transmitting and receiving frames to and from the medium respectively. For example, when the station 10 is a network appliance of a wireless network, and when the wireless network complies with the IEEE 802.11 protocol or the IEEE 802.11e protocol, the medium managed by the media access control circuit 20 is a wireless medium, i.e., a space or the atmosphere capable of transmitting radio waves. The media access control circuit 20 determines whether the station 10 may access the wireless medium and therefore communicate with other network appliances within the wireless network (e.g., other stations or access points) by utilizing appropriate procedures and frames having specific forms. The transceiver circuit 22 is utilized to implement the functions of the physical layers, and the functions are for modulating, encrypting, and processing of the frames transmitted from the media access control circuit 20 with a baseband circuit and a radio circuit. The transceiver circuit 22 is also utilized to receive the frames and transmits the frames to the media access control circuit 20. Please refer to FIG. 1 again. When the station 10 has the enhanced coordinate functions for supporting the four traffic categories TC1, TC2, TC3, and TC4, the drivers of the network interface circuit 18 in the station 10 includes software programs for identifying the traffic categories TC1, TC2, TC3, and TC4 in FIG. 2. When the central processing unit 12 accesses the network with a frame of a specific traffic category according to an application requirement, the corresponding software program of the specific traffic category are executed. The memory 16 stores the frames of some specific traffic categories such as the frames labeled as TC1, TC2, TC3 and TC4 in FIG. 2.

The media access control circuit 20 comprises a multiplex module 24, an internal access module 26, a register module 28, a pre-processing circuit 30, a predicting module 32, a master module (MAC controller) 34, and a register control module 36. The master module 34 controls the media access control circuit 20 for setting the back-off time intervals of the traffic categories and accessing the medium. The internal access module 26 accesses the memory 16 through the multiplex module 24 and the bridge 14. Also, the internal access module 26 internally accesses a frame of a traffic category each time for loading the frame from the memory 16 to the network interface circuit 18. For example, when the network interface circuit 18 connects to the bridge 14 with buses of peripheral communication interconnection (PCI), the internal access module 26 may be implemented with a direct memory access (DMA) circuit having said buses. Therefore, the internal access module 26 directly accesses the memory 16 through the bridge 14. The multiplex module 24 is utilized for determining which traffic category having a frame to be internally accessed by the interval access module 26. The register module 28 is utilized for storing the frame accessed by the internal access module 26, which may be implemented with a first-in-first-out (FIFO) register. The pre-processing circuit 30 is utilized for pre-processing the frame stored in the register module 28 for performing such operations as encryptions. The register control module 36 is utilized for manipulating the register 28. For example, after the pre-processing circuit 30 pre-processes the frame, the register control module 36 transmits the frame to the transceiver circuit 22 so that the frames are transmitted to the medium. The media access control circuit 20 further comprises a predicting module 32, which is utilized for evaluating the priorities of the traffic categories according to the back-off time intervals set by the master module 34. Whereby, the predicting module 32 proceeds to manipulate the internal access module 26 according to predicted priorities. Therefore, the internal access mechanism of the network interface circuit 18, the internal access mechanism comprising retrieving frames from the system memory 16, and the network media access mechanism utilized to transmit frames to the medium thus coordinate with each other. As a result, the enhanced coordinate functions are implemented with simplified circuits.

In the present invention, the operations of the media access control circuit 20 are described as follows. As the mentioned before, under the enhanced coordinate functions, the back-off time intervals of the traffic categories are set when the medium begins to idle, and the back-off time intervals of the traffic categories are counted down to contend for access to the medium. When the medium begins to idle and the back-off time intervals of the traffic categories have been set, the predicting module 32 of the present invention determines the priorities of the traffic categories according to the back-off time intervals, and the predicting module 32 determines which frame of a traffic category will be transmitted. A traffic category having a frame to be transmitted and having a smaller back-off time interval thereby has a higher priority. After determining the priorities of the traffic categories, the predicting module 32 controls the internal access module 26 for exclusively accessing the frame of the traffic category having the highest priority by utilizing the manipulations of the multiplex module 24. When the internal access module 26 loads the frame of the traffic category having the highest priority from the memory 16 and stores the frame in the register module 28, the pre-processing circuit 30 may pre-process the frame for some specific functions such as encryptions. Next, as the operations of the internal access module 26, the register module 28, and the pre-processing circuit 30 work at the same time, the back-off time intervals of the traffic categories are kept on counting down. When the countdown of the corresponding back-off time interval of the traffic category having the highest priority finishes to gain access to the medium, the frame of the traffic category having the highest priority has also been stored in the register module 28 and pre-processed. Lastly, the frame is transmitted to the transceiver circuit 22 by the register control module 36 so that the frame can be transmitted to the medium.

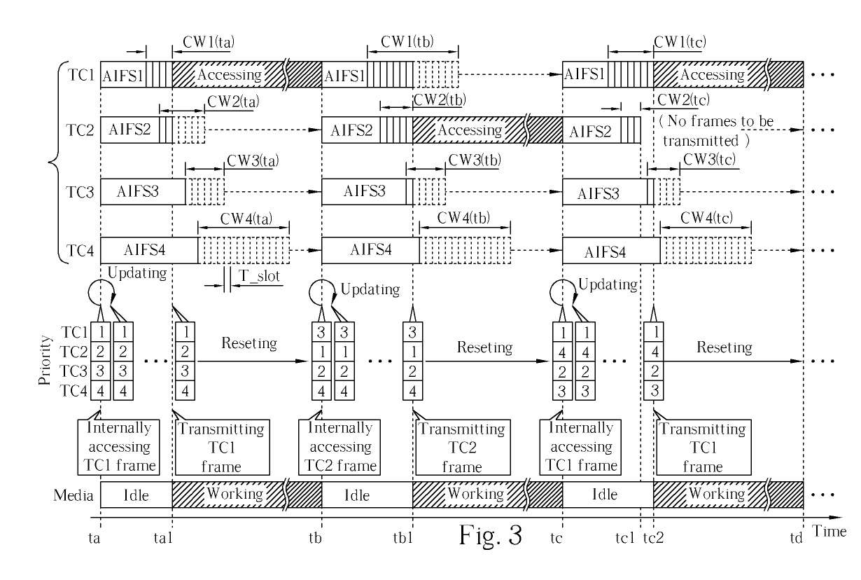

Please refer to both FIG. 2 and FIG. 3 simultaneously. FIG. 3 is a diagram of the media access control circuit 20 performing the enhanced coordinate functions of the present invention. The horizontal axis of FIG. 3 indicates time. Similarly, as shown in FIG. 1, when the medium is idle at the time ta and each traffic category of the station 10 has a frame to be transmitted, the frames of the traffic categories are still stored in the memory 16 by the software relating to the traffic categories. At the time ta, the master module 34 sets back-off time intervals for the corresponding traffic categories TC1, TC2, TC3, and TC4 respectively, and the predicting module 32 determines the priorities of the traffic categories according to the back-off time intervals. In FIG. 3, at the time ta, the back-off time interval (AIFS1+CW1 (ta)) is the shortest, therefore the traffic category TC1 has the highest priority. In FIG. 3, the priority of the traffic category TC1 is denoted as “1”, and is indicated at the top of the stack at the time ta, and therefore, the priority of the traffic category TC1 is the highest. The back-off time interval (AIFS4+CW4 (ta)) is the longest, and therefore, the traffic category TC4 has the lowest priority. In FIG. 3, the priority of the traffic category TC4 is denoted as “4” at the bottom of the stack at the time ta, and therefore, the priority of the traffic category TC4 is the lowest. The predicting module 32 determines the highest priority of the traffic category TC1 and orders the internal access module 26 to load a frame of the traffic category TC1 from the memory 16 and to store the frame into the register module 28 by utilizing the multiplex module 24. After loading the frame into the register module 28, the pre-processing circuit 30 pre-processes the frame. When the predicting module 32, the internal access module 26, and the pre-processing module 30 operate after the time ta, the back-off time intervals of the traffic categories are kept on counting down. The predicting module 32 regularly updates the priorities of the traffic categories when the back-off time intervals are still counted down. The priorities of the traffic categories are updated during each fixed updating period according to the clocked back-off time intervals, and the priorities of the traffic categories are updated when a frame of each traffic category is to be transmitted. In a preferred embodiment of the present invention, the updating period of the predicting module 32 may be equal to the time slot T_slot in the contention window.

At the time ta1, the countdown of the back-off time interval of the traffic category TC1 is finished prior to the other traffic categories, and therefore the traffic category TC1 gains access to the medium. Whereby the internal access mechanism operates according to the priorities, the frame of the traffic category TC1 has been stored in the register module 28 and has already been pre-processed. Therefore, at the time ta1, the register control module 36 transmits the frame of the traffic category TC1 in the register module 28 to the transceiver circuit 22, and then the transceiver circuit 22 transmits the frame to the medium for authorizing the traffic category TC1 to access to the medium. When the frame of the traffic category TC1 releases access to the medium at the time tb, the master module 34 is aware that the medium is idle and resets the back-off time intervals of the traffic categories. The resetting procedure has been introduced in FIG. 1, and therefore a redundant description will be omitted for the sake of brevity. In FIG. 3, at the time tb, the traffic categories TC1, TC2, TC3, and TC4 have frames to be transmitted respectively. Assuming that the traffic category TC1 has a second frame to be transmitted and the traffic categories TC2 and TC4 are also waiting for the access to the medium (i.e., contending for access to the medium) since both the traffic categories TC2 and TC4 do not gain access at the time ta. Therefore, in FIG. 3, at the time tb, the traffic category TC2 has the shortest back-off time interval (AIFS2+CW2 (tb)). The predicting module 32 again determines the priorities of the traffic categories according to the updated back-off time intervals so that the traffic category TC2 has the highest priority. After the time tb, the corresponding back-off time intervals are counted down respectively. The internal access module 26 loads a frame of the traffic category TC2 from the memory 16 to the register module 28 according to the priorities determined at the time tb. Therefore, the pre-processing module 30 pre-processes the frame. While the back-off time intervals are kept on counting down, the priorities are also updated. At the time tb1, the countdown of the traffic category TC2 is finished, then the traffic category TC2 gains access to the medium. Therefore, the frame of the traffic category TC2 is stored in the register module 28 and pre-processed, and then the register control module 36 transmits the frame from the register module 28 to the medium by utilizing the transceiver circuit 22.

At the time tc, the medium is once again idle, and the back-off time intervals of the traffic categories are also reset. In FIG. 3, at the time tc, the traffic category TC2 has the shortest back-off time interval, however, the traffic category TC2 has no frames to be transmitted at the time tc, therefore, the predicting module 32 upgrades the priority of the traffic category TC1, which does have a frame to be transmitted and has a back-off time interval of which the length is the second shortest. Therefore, the priority of the traffic category TC1 thus becomes the highest. The internal access module 26 is also exclusively ordered to process the access of the frame of the traffic category TC1. While the back-off time interval of the traffic category TC2 are still counted down, the predicting module 32 continuously detects whether the traffic category TC2 has a frame to be transmitted. When the traffic category TC2 has no frame to be transmitted, the traffic category TC1 maintains the highest priority. At the time tc1, when the traffic category TC2 still has no frames to be transmitted, the corresponding back-off time intervals of other traffic categories are kept on counting down. At the time tc2, the countdown of the traffic category TC1 is finished, whereby that the traffic category TC1 gains access to the medium. The internal access mechanism thus loads a frame of the traffic category TC1 into the register module 28 so that the register control module 36 transmits the frame to the transceiver circuit 22 for transmitting the frame to the medium.

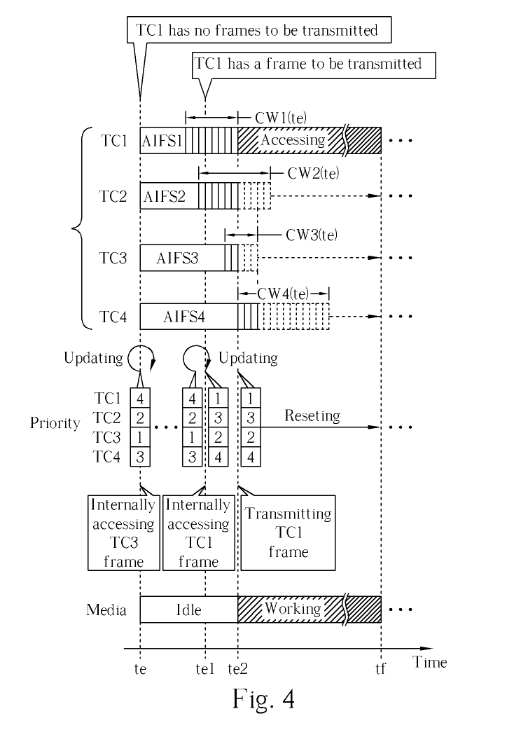

In the embodiment of FIG. 2, if the priorities are updating and the predicting module 32 is aware that the priorities have changed, the internal access module 26 is informed to internally access the traffic category having an updated highest priority. Please refer to FIG. 4. FIG. 4 is a diagram of the operations of the media access circuit 20 while the priorities of the traffic categories are updated. Please also refer to FIG. 2. The horizontal axis of FIG. 4 indicates time. In FIG. 4, when the medium is idle at the time te, the traffic category TC1 has the shortest back-off time interval. However, the traffic category TC1 has no frames to be transmitted, and the predicting module 32 thus upgrades the priorities of the other traffic categories. Next, the traffic category TC3 has the highest priority since the length of the back-off time interval of the traffic category TC3 is the second shortest. The highest priority of the traffic category TC3 is shown with a character 1 in FIG. 4. The internal access module 26 performs the internal access according to the updated priorities at the time te and loads a frame of the traffic category TC3 from the memory 16. The countdown of each traffic category proceeds from the time te, and the predicting module 32 updates the priorities with respect to the countdowns. At the time te1, the traffic category TC1 has a frame in the memory 16 to be transmitted, and the predicting module 32 updates the priorities again so that the traffic category TC1 has the highest priority. The internal access module 26 thus loads the frame of the traffic category TC1 from the memory 16 to the register module 28, and pre-processes the frame. When the register module 28 is implemented with first-in-first-out (FIFO) registers, and buffers the frame of the traffic category TC3, the frame being loaded by the internal access module 26 during the times te and te1, the register module 28 temporarily pops the frame of the traffic category TC3 off. When the back-off time interval of the traffic category TC1 is finished at the time te2, and the traffic category TC1 gains access to the medium, the register control module 36 transmits the frame of the traffic category TC1 from the register module 28 to the transceiver circuit 22 for transmitting the frame to the medium. Moreover, the popped-off frame of the traffic category TC3 at the time te1 is not stored in the register module 28 until the traffic category TC3 regains the highest priority. Please note that the register module 28 may be implemented with a first-in-first-out (FIFO) register capable of storing two frames.

From the description in FIG. 2, FIG. 3, and FIG. 4, the media access control circuit 20 coordinates the internal access mechanism and the media access mechanism of the network interface circuit according to the updated priorities from the predicting module 32. Therefore, the frame that will be transmitted to the medium is exclusively loaded from the system memory. Without the coordinating mechanism, it is not possible to inform the internal access mechanism that which frame will be transmitted to the medium, and the network interface circuit thus has to maintain four independent internal access modules, four independent register modules, four independent pre-processing circuits, and four independent register control modules for simultaneously loading the frames of the four traffic categories and for supporting the four traffic categories according to the enhanced coordinate functions. On the contrary, the coordinating mechanism of the present invention simplifies the network interface circuit and the media access control circuit. As a result, the present invention merely requires an internal access module, a register module, a register control module, and a pre-processing circuit. Said internal access module and said pre-processing circuit are all that is required for supporting the enhanced coordinate functions of four or more traffic categories.

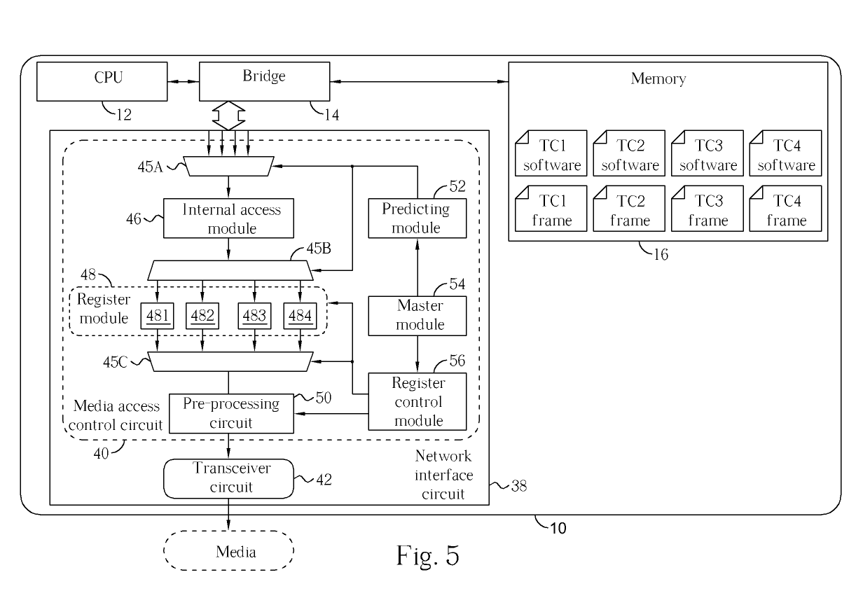

Please refer to FIG. 5. FIG. 5 is a block diagram of a second embodiment of the station 10 of the present invention. As shown in FIG. 5, the network interface circuit 38 is utilized to cooperate with the central processing unit 12, the bridge 14, and the memory 16 utilized as a system memory in the station 10. The network interface circuit 38 comprises a media access control circuit 40 and a transceiver circuit 42, for implementing the functions of the physical layer. The media access control circuit 40 comprises multiplex modules 45A, 45B, and 45C, an internal access module 46, a register module 48, a pre-processing circuit 50 utilized for pre-processing a frame, a predicting module 52, a master module 54, and a register control module 56. The master module 54 is utilized for manipulating the media access control circuit 40 for operations including setting the back-off time intervals for the traffic categories and managing the competition for access to the medium. The internal access module 46 is utilized for accessing the memory 16 through the bridge 14, and for a frame internal access. In the embodiment of FIG. 5, the register module 48 comprises four registers 481, 482, 483, and 484 relating to the four traffic categories supported by the media access control circuit. For example, the register 481 belongs to the traffic category TC1, the register 482 belongs to the traffic category TC2, the register 483 belongs to the traffic category TC3, and the register 484 belongs to the traffic category TC4. The registers 481, 482, 483, and 484 are also utilized for storing a frame of a corresponding traffic category. The register control module 56 is utilized for manipulating the registers 481, 482, 483, and 484 for transmitting a frame in a specific register to the transceiver circuit 42. The pre-processing circuit 50 is utilized for pre-processing the frames stored in the registers for executing such functions as encryptions.

Similar to the embodiment of FIG. 2, the predicting module 52 shown in FIG. 5 is also utilized to set the priorities of the traffic categories according to the countdowns of the back-off time intervals generated from the master module 54 for coordinating the internal access mechanism and the media access mechanism in the media access control circuit 40. The operations of the media access control circuit 40 are described as follows. When the medium is idle and the back-off time intervals of the traffic categories are also set, the predicting module 54 sets the priorities of the traffic categories according to corresponding back-off time intervals and according to that whether the traffic categories have frames to be transmitted. After determining the traffic category having the highest priority, the predicting module 54 controls the internal access module 46 to load a frame of the traffic category from the memory 16 by utilizing the multiplex modules 45A and 45B, and buffers (even pre-processes) the frame in the register relating to the traffic category. Contrary to the embodiment of FIG. 2, after loading the frame of the traffic category having the highest priority into the corresponding register, the internal access module 46 of FIG. 5 loads a frame of a traffic category having a second priority, and so on, while the back-off time intervals are still counted down. Therefore, all the traffic categories have a frame loaded and stored in a corresponding register while each back-off time interval is counted down. After the countdown is finished, and the medium is idle again, the predicting module 52 updates the priorities of the traffic categories, and coordinates the internal access module 46 and the pre-processing circuit 50 according to the updated priorities and according to whether the traffic categories have frames to be transmitted. Since the internal access module 46 continuously loads frames of the traffic categories from the memory 16 before updating the priorities, a frame of the traffic category having the highest priority has been stored in a corresponding register. After updating the priorities, the internal access module 46 does not load the frame of the traffic category having the highest priority from the memory 16, and instead the pre-processing circuit 50 directly pre-processes the stored frame.

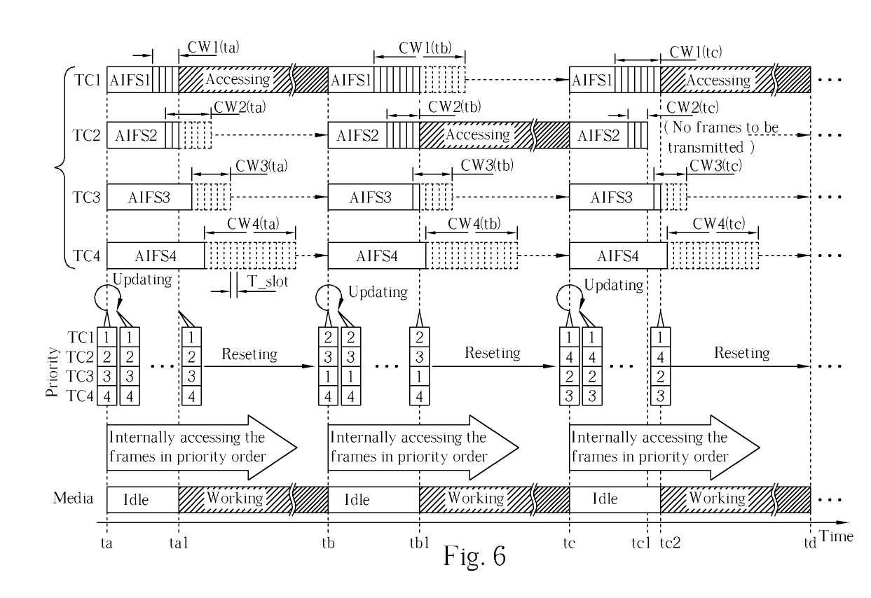

Please refer to FIG. 6. FIG. 6 is a diagram of the media access control circuit 40 performing the enhanced functions. Also, please refer to FIG. 1 and FIG. 5 for reference. The horizontal axis in FIG. 6 indicates time. When the medium is idle at the time ta, the corresponding back-off time intervals (AIFSi+Cwi (ta)) are assigned to the traffic categories TC1, TC2, TC3, and TC4 respectively, wherein i ranges from 1 to 4, and each of the traffic categories has at least one frame to be transmitted. The predicting module 52 sets the priorities of the traffic categories, and the priorities are arranged in the descending order {TC1, TC2, TC3, TC4} as shown in FIG. 6 at the time ta. When the registers 481, 482, 483, and 484 relating to the traffic categories have no stored frames, and the countdowns of the traffic categories are clocked at the time ta, the predicting module 52 controls the internal access module 46 to load a frame of the traffic category TC1 from the memory 16 to the register 481 according to the priorities. Next, a frame of each of the traffic categories TC2, TC3, TC4 is also sequentially loaded from the memory 16 to the registers 482, 483, and 484. If there is enough time, the internal access module 46 loads frames of the traffic categories sequentially according to the priorities of the traffic categories until each traffic category has at least one frame stored by a corresponding register. In fact, in a preferred embodiment of the present invention, the registers are only required to store one frame. After the internal access module 46 loads a frame of the traffic category TC1 from the memory 16 to the register 481, the internal access module 46 continues loading frames of the other traffic categories and the pre-processing circuit 50 simultaneously pre-processes the frame stored in the register 481. While the back-off time intervals are counted down, the predicting module 52 periodically updates the priorities of the traffic categories according to the deceasing back-off time intervals of the traffic categories, and according to whether the traffic categories have frames to be transmitted.

At the time ta1, the countdown of the back-off time interval of the traffic category TC1 is finished first, and the traffic category TC1 thus gains access to the medium. The register control module 56 thus transmits the frame stored in the register 481 to the transceiver circuit 42 by utilizing the multiplex module 45C for transmitting the frame to the medium. When the media is idle again at the time tb, the corresponding back-off time intervals are reset respectively, and the predicting module 52 again updates the priorities. At the time tb, the descending priority order of the traffic categories is {TC2, TC3, TC1, TC4} at the time tb as shown in FIG. 6. Therefore, a frame of the traffic category TC2 is loaded by utilizing the internal access mechanism. However, the internal access module 46 sequentially loads the frame of the traffic categories after the time ta, when the internal access module 46 works at a sufficiently high efficiency. The internal access module 46 stores the frames of the traffic categories TC2, TC3, and TC4 into the registers 482, 483, and 484 at the time tb. Then a frame of the traffic category TC2 is stored into the register 482, and the pre-processing circuit 50 pre-processes the frame in the register 482. Moreover, the frame in the register 481 has been transmitted at the time ta1, and therefore the register 481 may be regarded as being empty. When the traffic category TC1 still has at least one frame to be transmitted, the internal access module 46 loads a second frame of the traffic category TC1 from the memory 16 to the register 481. In other words, at the time tb, the descending order of the priorities is {TC2, TC3, TC1, TC4}. However, before the time tb, the internal access module 46 may merely load a frame for the empty register when the frames of the traffic categories TC2, TC3, and TC4 have been loaded to corresponding registers. In other words, the internal access module 46 loads a frame of the traffic category TC1 to the empty register 481 when the traffic category 481 still has at least one frame to be transmitted.

However, instead of working at a sufficiently high efficiency mode, the internal access module 46 merely loads the frames of the traffic categories TC1 and TC2 into the registers 481 and 482, and the frames of the traffic categories TC3 and TC4 are not yet loaded into the registers 483 and 484 when the internal access module 46 works in a low efficiency mode between the times ta and tb. Therefore, at the time tb, the registers 481, 483, and 484 are empty since the frame previously stored in the register 481 has already been transmitted. The internal access module 46 tries sequentially loading frames of the traffic categories TC1, TC3, and TC4 to the registers 481, 483, and 484 according to the priorities of said traffic categories. When the internal access module 46 loads the abovementioned frames at the time tb, the pre-processing circuit 50 may still pre-process the frame of the traffic category TC2, which has the highest priority at the time tb.

In other words, when the priorities are updated, the internal access module 46 determines that which internal accesses will be processed according to that whether the registers corresponding to the traffic categories contain stored frames. After the priorities are updated and when there is a plurality of registers having no stored frames, the internal access module 46 determines that which traffic category internally accesses a corresponding frame first according to the updated priorities of the traffic categories. In FIG. 6, at the time tc, it is possible that the internal access module 46 does not perform the internal access since the traffic categories TC1, TC3, and TC4 may have frames stored in the corresponding registers between the times tb and tc while the traffic category TC2 has no frame to be transmitted. When the internal access module 46 works in a low efficiency and only performs the internal accesses on the traffic category TC1 and TC3 between the times tb and tc instead of the traffic category TC4, the internal access module 46 performs the internal access by utilizing the traffic category TC4 at the time tc. At the same time, the pre-processing circuit 50 exclusively pre-processes a frame of the traffic category TC1 in the register 481 according to the priorities at the time tc.

In the present invention, both the embodiment shown in FIG. 2 and the embodiment shown in FIG. 5, with the internal access mechanism, the internal access is performed for a frame of each traffic category according to the priorities of the traffic categories. Therefore, a frame of the traffic category having the highest priority is prepared according to the internal access mechanism by the pre-processing circuit. The internal access mechanism shown in FIG. 2 is stopped working after loading a frame of the traffic category having the highest priority whereas the internal access mechanism shown in FIG. 5 is performed for continuously loading the frames of other traffic categories according to present priorities after loading the frame of the traffic category having the highest priority. Therefore, the internal access mechanism shown in FIG. 2 is suitable for a computer system running with a faster internal access mechanism while the internal access mechanism shown in FIG. 5 is well adopted for a computer system running with a slower internal access mechanism.

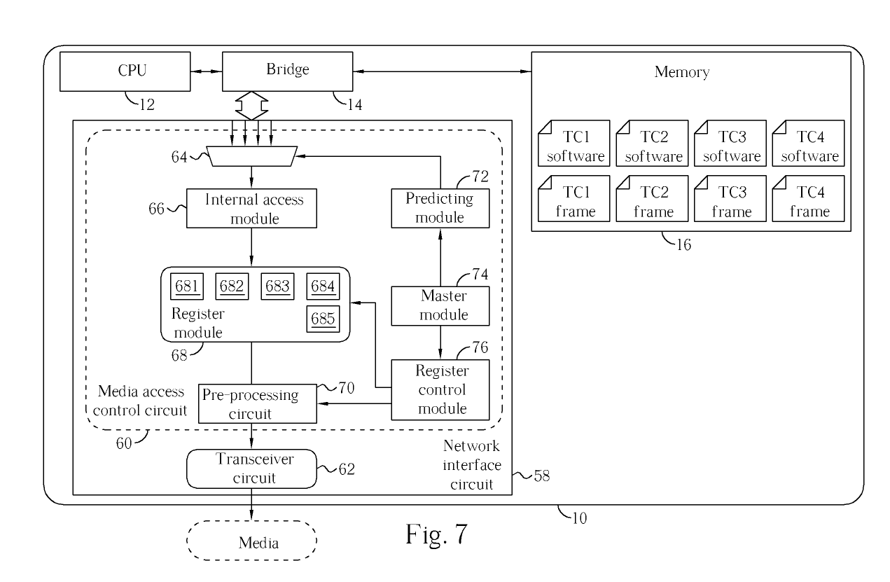

However, the media access control circuit 60 may also replace the media access control circuit 40 of FIG. 5. Please refer to FIG. 7. FIG. 7 is a block diagram of a third embodiment of the station 10 of the present invention. Please also refer to FIG. 5 for reference. In FIG. 7, the network interface circuit 58 cooperates with the central processing unit 12, the bridge 14, and the memory 16. Except for the media access control circuit 60, the network interface circuit 58 also comprises a transceiver circuit 62 to implement the network's physical layer functions. The media access control circuit 60 comprises a multiplex module 64, an internal access module 66, a register module 68, a pre-processing circuit 70, a predicting circuit 72, a master module 74, and a register control module 76. The functions of the multiplex module 64 are equivalent to the functions of the multiplex module 45A shown in FIG. 5. The functions of the internal access module 66 are equivalent to the functions of the internal access module 46 shown in FIG. 5. The functions of the pre-processing circuit 70 are equivalent to the functions of the pre-processing circuit 50 shown in FIG. 5. The functions of the predicting module 72 are equivalent to the functions of the predicting module 52 shown in FIG. 5. The functions of the master module 74 are equivalent to the functions of the master module 54 shown in FIG. 5. Therefore, redundant descriptions of said equivalent components will be omitted herein for the sake of brevity. The register module 68 may be implemented with a random access memory (RAM) such as a static random access memory. The register module 68 comprises four memory units 681, 682, 683, and 684, and the memory units are for the purpose of storing frames of different traffic categories respectively. Therefore, the register module 68 is utilized to implement the register module 48 shown in FIG. 5. The memory units 681, 682, 683, and 684 of the register module 68 are utilized to implement the registers 481, 482, 483, and 484 of the register module 48. The register control module 76 is a control module for randomly accessing the memory units. The frames in the memory units 681, 682, 683, and 684 are transmitted by the register control module 76 to the transceiver circuit 62 for transmitting the frames to the medium.

Moreover, the media access control circuit 60 of FIG. 7 and the media access control circuit 40 of FIG. 5 have several operation modes in common. The common operation modes include the following types. When a frame is loaded, it is to be determined that which frame of a traffic category is loaded from the memory 16 with the internal access mechanism according to the priorities of the traffic categories so that the corresponding frame is stored in a register or a memory unit. Moreover, the pre-processing circuit 70 pre-processes a frame stored in a specific register or a specific memory unit according to the priorities of the traffic categories. As the mentioned above, a preferred embodiment shown in FIG. 5 enables each of the registers 481, 482, 483, and 484 to just store one frame. Additionally, each of the memory units 681, 682, 683, and 684 in FIG. 7 merely stores a frame.

Besides, as shown in FIG. 7, the register module 68 further provides a memory unit 685, which is regarded as an additional temporary register, for supporting a frame transmission under a burst mode. For example, when two successive frames are transmitted sequentially, the first frame is stored in the register or the memory unit of the corresponding traffic category and the next frame is stored in the temporary register or in the memory unit 685. In a preferred embodiment of the present invention, the burst mode for frame transmission is easily supported with the memory unit 685 that only needs to store a single frame. Similarly, the register module 48 in FIG. 5 further provides a temporary register for supporting frame transmission under the burst mode.

In fact, with comparing FIG. 2 and FIG. 7, the media access control circuit 60 in FIG. 7 could replace the media access control circuit 20 in FIG. 2. As the related description of FIG. 2 and in a preferred embodiment of the present invention, the register module 28 may be implemented with a register capable of simultaneously storing two frames. Also, the register module 28 in FIG. 2 can replace the register module 68, which is implemented with a random access memory in FIG. 7. As the described above, the embodiments of FIG. 2 and FIG. 5 may be integrated into a single hardware device. Therefore, the hardware device may be utilized to optionally implement the embodiment of either FIG. 2 or FIG. 7 by adjusting the internal access mechanism and the operations of the register module.

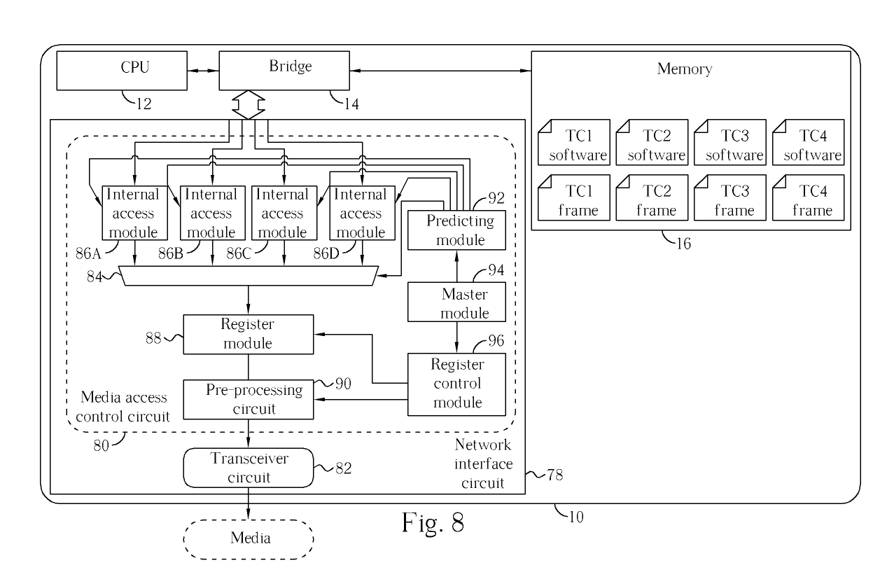

Please refer to FIG. 8. FIG. 8 is a diagram of another embodiment of the network interface circuit and the media access control circuit in the station 10 of the present invention. The network interface circuit 78 comprises a media access control circuit 80 and a transceiver circuit 82. The media access control circuit 80 comprises four internal access modules 86A, 86B, 86C, and 86D, a multiplex module 84, a register module 88, a pre-processing circuit 90, a predicting module 92, a master module 94, and a register control module 96. The embodiment of FIG. 8 may be utilized to implement the embodiments shown in FIG. 2, FIG. 5, and FIG. 7. However, in the embodiment of FIG. 8, the internal access modules 86A, 86B, 86C, and 86D are utilized to implement the internal access mechanism and to perform the internal access on the frames of the traffic categories TC1, TC2, TC3, and TC4 respectively. The functions of the register module 88, the pre-processing circuit 90, the predicting module 92, the master module 94, and the register control module 96 are identical to the elements having the same reference labels as shown in FIG. 2, FIG. 5, and FIG. 7. Therefore, the media access control circuit 80 can be utilized to implement the media access control circuits shown in FIG. 2, FIG. 5, and FIG. 7.

As the mentioned before, the internal access modules of FIG. 2, FIG. 5, FIG. 7, and FIG. 8 may be implemented with a direct memory access (DMA) circuit having peripheral communication interconnection (PCI) buses. Therefore, such an internal access module actively provides bus master services, and performs the direct memory access for internally accessing a frame. Additionally, the internal access module may be implemented with a passive internal access circuit such as an internal access circuit having universal serial buses (USB). Under some bus protocols, the internal access circuits are polled for a data access instruction according to the bus master mechanism and an internal access circuit performs the internal access while the internal access circuit is passively polled. The embodiments of the present invention may be utilized to implement the active and the passive internal access mechanisms.

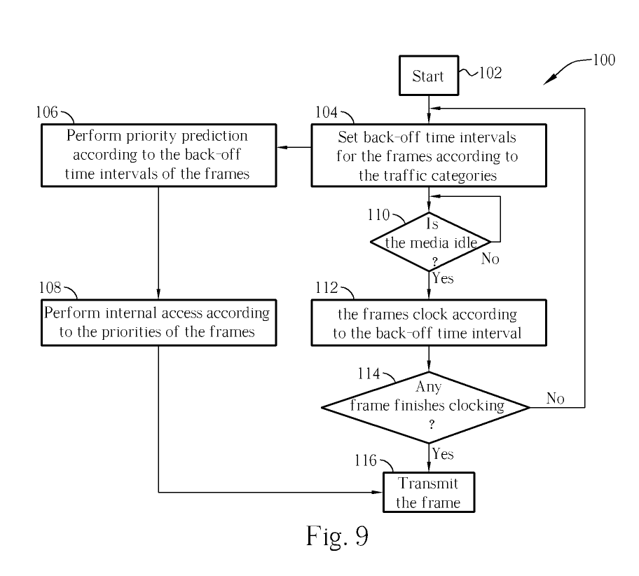

Please refer to FIG. 9. FIG. 9 is a diagram of procedure 100 of the present invention, wherein procedure 100 summarizes the operations of the embodiments of the present invention. Please refer to FIG. 2, FIG. 5, FIG. 7, and FIG. 8. Procedure 100 of the present invention is performed while the station 10 transmits frames of various traffic categories to a medium such as a wireless medium. Procedure 100 comprises the following steps:

Step 102: Performing procedure 100 while the station 10 has a frame to be transmitted. As the mentioned previously, the frames are grouped into various traffic categories for supporting quality of service (QoS).

Step 104: Setting back-off time intervals for frames of different traffic categories.

Step 106: Performing a priority prediction. The priorities of the frames are dependent on the back-off time intervals of the traffic categories having the frames. A frame with a shorter back-off time interval has a higher priority.

Step 108: Performing the internal access in the station according to the results of the priority prediction. A frame with a higher priority is exclusively loaded to the network interface circuit. As described in FIG. 2, FIG. 5, FIG. 7, and FIG. 8, various circuit arrangements may be utilized to perform Step 108. The loaded frame may also be pre-processed (such as encrypted) if necessary.

Step 110: Continuously detecting whether the medium is idle while performing the Steps 106 and 108. When the medium is idle, proceed to Step 112.

Step 112: Counting down the back-off time intervals corresponding to the frames, which will be transmitted, according to the corresponding back-off time intervals respectively.

Step 114: When the countdown corresponding to a specific frame is finished and the medium remains idle, proceed to Step 116. For the other frames having unfinished countdowns, proceed to Step 104.

Step 116: Transmitting the frame loaded in Step 108 to the medium for transmitting the frame to the network.

In summary, for supporting a network having the enhanced coordinate functions according to the quality of service (QoS) specifications, the priorities of the traffic categories are set according to the priority of the traffic categories. Before the frames of the traffic categories are transmitted to the medium, internal accesses on the frames are performed according to the priorities. Therefore, the internal access mechanism and the media access mechanism are coordinated. Without this coordinating mechanism, the internal access mechanism cannot be notified when a frame of a particular category is transmitted exclusively. Each traffic category must have an independent internal access mechanism for processing the cooperation of the internal access module, the register module, the pre-processing circuit, and the register control module. Therefore, the frame that will be transmitted is prepared before the corresponding traffic category gains access to the medium. In the present invention, the priorities of the traffic categories are properly evaluated while the traffic categories contend for access to the medium for coordinating the internal access mechanism and the media access mechanism. Therefore, even with a single internal access mechanism, it is necessary to prepare a frame to be transmitted by assigning a traffic category for gaining access to the medium. Without affecting the enhanced coordinate functions, the present invention simplifies the circuit structure of the media access circuit and the network interface circuit, and decreases the cost to manufacture said circuit structure. Additionally, the area, and the power consumption of the network interface circuit are both reduced by the present invention. The present invention easily integrates with networks and buses that support the quality of service feature, such as the wireless networks utilizing the IEEE 802.11 protocols and IEEE 802.11e protocols. The elements of the network interface circuit and the media access circuit in the present invention may be implemented by hardware or by firmware.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of media access control (MAC) implementation for enabling a station to access a network through a medium, the method comprising:
setting a plurality of traffic categories;
conforming each of a plurality of frames to one of the traffic categories before the station transmits information in the form of the frames to the medium;
identifying that whether the medium is idle before the frames are ready to be transmitted;
assigning a specific one of a plurality of back-off time intervals to the frames respectively while the medium is idle;
buffering a group of frames, which belong to a high priority group of the traffic categories, to a register module according to a priority prediction if the group of frames are transmitted to the medium; and
starting a countdown according to the specific one of the back-off time intervals while the priority prediction is performed;
wherein the back-off time intervals, which determines a priority of each of the traffic categories, are compared by the priority prediction, and a specific frame is transmitted from the register module to the medium if the idle time of the medium reaches a specific back-off time interval assigned to the specific frame that is buffered in the register module.

2. The method of claim 1 further comprising:
eliminating the group of frames buffered in the register module for buffering a given frame in the register module if the given frame, which belongs to a given one of the traffic categories that has the highest priority, is to be transmitted to the medium, before the group of frames are transmitted to the medium, and after the priority prediction is performed.

3. The method of claim 2 wherein the register module is a first-in-first-out (FIFO) register capable of buffering at least two frames.

4. The method of claim 1 further comprising:
buffering the group of frames that belong to a low priority group of the traffic categories in the register module according to a priority order before the frame is transmitted to the medium, and after the priority prediction is performed.

5. The method of claim 4 wherein the register module buffers at least one frame for each of the traffic categories.

6. The method of claim 1 further comprising:
conforming each of the traffic categories to each of a plurality of arbitration inter-frame spaces (AIFS) with different time intervals;
conforming each of the traffic categories to each of a plurality of contention windows with different time intervals;
performing a random selection on each of the traffic categories to randomly select a period of time that is regarded as a specific contention window corresponding to a specific traffic category within a range of each of the contention windows; and
making each of the traffic categories equal to a sum of each of the contention windows and each of the arbitration inter frame spaces.

7. The method of claim 1 further comprising:
setting an updating period; and
updating the priority of each of the traffic categories in every updating period within a idle time if the medium remains idle after the priority prediction is performed.

8. The method of claim 7 further comprising:
resetting the back-off time intervals corresponding to the traffic categories if the frame has been transmitted to the medium after the priority prediction is performed.

9. The method of claim 7 further comprising:
setting a fixed time slot;
conforming each of the traffic categories to a parameter of each of the contention windows with different time intervals;
performing a random selection on each of the traffic categories to randomly select a integer, which is multiplied by the fixed time slot to generate a time period regarded as a specific contention window corresponding to a specific traffic category, within the parameter;
conforming each of the traffic categories to each of the arbitration inter-frame spaces with different time intervals; and
making each of the traffic categories equal to a sum of each of the contention windows and each of the arbitration inter frame spaces.

10. The method of claim 9 further comprising:
making the fixed time slot equal to the updating period.

11. The method of claim 1 further comprising:
transmitting the group of frames in the form of a plurality of radio waves to the medium that can be a space capable of transmitting the radio waves.

12. A media access control circuit for enabling a station to access a network by transmitting information in the form of a plurality of frames to the medium, the media access control circuit comprising:
a register module;
a master module, which identifies whether the medium is idle to transmit the frames, for controlling the operation of the media access control circuit;
a predicting module for performing a priority prediction to compare a plurality of back-off time intervals corresponding to a plurality of traffic categories and determine a priority of each of the traffic categories according to the back-off time intervals when the medium is idle and the master module conforms each of the traffic categories to each of back-off time intervals;
an internal access module for buffering a group of frames, which belongs to a high priority group of the traffic categories in a register module according to priority predicted by the predicting module when the group of frames, which belong to different traffic categories, are ready to transmitted to the medium; and
a register control module for transmitting a specific frame to the medium from the register module when the medium idle time reaches a specific back-off time interval assigned to the specific frame in the register module.

13. The media access control circuit of claim 12 wherein the register control module eliminates the group of frames buffered in the register module for buffering a given frame in the register module if the given frame, which belongs to a given one of the traffic categories that has the highest priority, is detected by the predicting module and is to be transmitted to the medium, before the group of frames are transmitted to the medium, and after the priority prediction is performed.

14. The media access control circuit of claim 13 wherein the register module is a first-in-first-out (FIFO) register capable of buffering at least two frames.

15. The media access control circuit of claim 12 wherein the internal access module continues buffering the group of frames that belong to a low priority group of the traffic categories in the register module according to a priority order before the frame is transmitted to the medium, and after the priority prediction is performed.

16. The media access control circuit of claim 15 wherein the register module buffers at least one frame for each of the traffic categories.

17. The media access control circuit of claim 12 wherein the master module conforms each of the traffic categories to each of a plurality of arbitration inter-frame spaces (AIFS) with different time intervals and conforms each of the traffic categories to each of a plurality of contention windows with different time intervals, and the master module performs a random selection on each of the traffic categories to randomly select a period of time that is regarded as a specific contention window corresponding to a specific traffic category within a range of each of the contention windows and makes each of the traffic categories equal to a sum of each of the contention windows and each of the arbitration inter frame spaces when the master module conforms each of the traffic categories to each of the back-off time intervals.

18. The media access control circuit of claim 12 wherein the predicting module further sets an updating period and updates the priority of each of the traffic categories in every updating period within a idle time if the medium remains idle after the priority prediction is performed.

19. The media access control circuit of claim 18, wherein the master module resets the back-off time intervals corresponding to the traffic categories if the frame has been transmitted to the medium after the priority prediction is performed.

20. The media access control circuit of claim 18 wherein the master module conforms each of the traffic categories to a parameter of each of the contention windows with different time intervals and conforms each of the traffic categories to each of the arbitration inter-frame spaces with different time intervals and the master module performs a random selection on each of the traffic categories to randomly select a integer, which is multiplied by the fixed time slot to generate a time period regarded as a specific contention window corresponding to a specific traffic category, within the parameter and makes each of the traffic categories equal to a sum of each of the contention windows and each of the arbitration inter frame spaces when the master module conforms each of the traffic categories to each of the back-off time intervals.

21. The media access control circuit of claim 20 wherein the predicting module makes the fixed time slot equal to the updating period.

22. The media access control circuit of claim 12 wherein the register module transmits the group of frames in the form of a plurality of radio waves to the medium that can be a space capable of transmitting the radio waves.
